(19) United States
(12) Patent Application Publication
(10) Pub. No.: US 2013/0209858 A1
(43) Pub. Date: Aug. 15, 2013

(54) HEAT DISSIPATER AND ELECTRICAL ENERGY STORAGE DEVICE

(71) Applicants: RAINER SCHMITT, AUGSBURG (DE); OSWIN OETTINGER, MEITINGEN (DE); CALIN WURM, MEITINGEN (DE); BASTIAN HUDLER, RAIN (DE); WERNER LANGER, ALTENMUENSTER (DE)

(72) Inventors: RAINER SCHMITT, AUGSBURG (DE); OSWIN OETTINGER, MEITINGEN (DE); CALIN WURM, MEITINGEN (DE); BASTIAN HUDLER, RAIN (DE); WERNER LANGER, ALTENMUENSTER (DE)

(73) Assignee: SGL CARBON SE, WIESBADEN (DE)

(21) Appl. No.: 13/587,097

(22) Filed: Aug. 16, 2012

Related U.S. Application Data
(63) Continuation of application No. PCT/EP2011/052317, filed on Feb. 16, 2011.

(30) Foreign Application Priority Data
Feb. 16, 2010 (DE) 10 2010 002 000.1

(51) Int. Cl. H01M 10/50

(52) U.S. Cl. CPC H01M 10/5046
USPC 429/120; 423/448; 252/71

(57) ABSTRACT

A heat dissipater has a graphite-containing flat material provided for adjacent positioning against one or more battery cells, as well as an electrical energy storage device with at least one battery cell and a heat dissipater for removing heat from the battery cell. The heat dissipater has a graphite-containing flat material and is disposed on at least one external face of the battery cell. Accordingly, the graphite-containing flat material contains graphite expandate.

### CROSS-REFERENCE TO RELATED APPLICATION

This application is a continuation, under 35 U.S.C. §120, of copending international application No. PCT/EP2011/052317, filed Feb. 16, 2011, which designated the United States; this application also claims the priority, under 35 U.S.C. §119, of German patent application No. DE 10 2010 002 000.1, filed Feb. 16, 2010; the prior applications are herewith incorporated by reference in their entirety.

### BACKGROUND OF THE INVENTION

### Field of the Invention

The invention relates to a heat dissipater according to the preamble of the claims and an electrical energy storage device according to the preamble of the claims.

There is known from U.S. patent publication No. 2006/0134514 A1 a traction battery for electric vehicles with a plurality of battery cells disposed in a housing and electrically connected to one another. Heat is generated in the battery cells during operation due to the charging-discharging cycles common with such batteries. In particular, a drawback for the useful life and reliability of battery cells is the so-called hotspots, i.e. locally concentrated overheating points, which in the worst case can damage the battery cell concerned. In order to eliminate this problem, there are disposed at the lateral faces and in particular between adjacent lateral faces of the battery cells foils or plates made of a material with a thermal conductivity in the planar direction of more than 250 W/(mK) and in the thickness direction of less than 20 W/(mK). The foils or plates can be made of graphite.

An example of such a graphite-containing foil or plate is disclosed by European patent EP 0 806 805 B1, corresponding to U.S. Pat. No. 5,786,107, which relates to a battery system with a heat conductor. The thermal function of the conductor is provided there by graphite-containing fibrous materials.

It has in the meantime emerged that the aforementioned battery cells exhibit a large change in thickness on account of the constant charging and discharging cycles during operation, in the case of lithium ion battery cells, for example, between 0.5 to 10%. In order to achieve the stated marked anisotropy of the thermal conductivity in the planar and thickness direction in the case of the aforementioned graphite plates or foils, the graphite must have a very high density, typically of more than 1.5 g/cm³. Such highly compacted graphite foils or plates are however very firm and only slightly compressible and elastic, i.e. can yield only slightly in the presence of a volume expansion of the battery cells clamped together. When the subsequent volume reduction takes place, wherein the distances between the battery cells again increases, the free spaces thus arising cannot be filled again by the plates. This gives rise on the one hand to great mechanical stresses and on the other hand to poor contacting of the lateral faces of the battery cells. Precisely in the latter case, due to a poor or completely absent connection of the plates with the battery cells, it cannot be ensured that the heat arising due to hotspots is rapidly distributed in the planar direction of the plates. Moreover, the heat of the hotspots can no longer be distributed sufficiently quickly in the presence of a continuously high thermal input into the plates due to their limited heat storage capacity.

### SUMMARY OF THE INVENTION

It is therefore the problem of the invention to make available a heat dissipater and an energy storage device, which overcome the aforementioned drawbacks and enable a uniform heat distribution at the battery cells as well as the removal of excess thermal energy.

This problem is solved by a heat dissipater with the features according to the claims and an electrical energy storage device with the features according to the claims. Advantageous developments and preferred embodiments of the heat dissipater and the energy storage device are given in the sub-claims.

According to the invention, a heat dissipater mentioned at the outset and an electrical energy storage device are characterized in that the graphite-containing flat material of the heat dissipater contains graphite expandate. It is thus possible to provide good thermal conductivity in the planar direction with at the same time good adaptability to volume changes of the battery cells in both directions—volume expansion and volume contraction. In addition, the graphite-containing flat material of the heat dissipater can be particularly readily adapted to the most varied forms of battery cells.

In an embodiment of the invention, the flat material has a density of 0.6-1.4 g/cm³, preferably of 0.7-1.3 g/cm³ and particularly preferably 0.9-1.1 g/cm³, such as an advantageous 1.0 g/cm³. In a further embodiment of the invention, the flat material has a thermal conductivity in the planar direction of 120-240 W/(mK), preferably of 130-230 W/(mK) and particularly preferably of 180-190, W/(mK).

In an embodiment of the invention, the flat material in the thickness direction has an elastic recovery of 0.5-15%, preferably of 1-10% and particularly preferably of 4-10%, related to its initial thickness, as a result of which the heat dissipater can spread out into the space becoming free in the presence of a volume reduction of the battery cells. Initial thickness is understood here to mean the thickness of the flat material without external surface pressure, i.e. in the state not compressed or clamped before the assembly of the energy storage devices. A durable connection between the battery cells and the heat dissipater with good thermal conductivity can thus be ensured.

In a still further embodiment of the invention, the flat material in the thickness direction has a compressibility of 1-50%, preferably of 5-35%, particularly preferably of 7-30% and very particularly preferably of 10-20%, related to its initial thickness, as a result of which the heat dissipater can yield in the presence of a volume expansion of the battery cells.

The flat material can preferably be made from compressed graphite expandate. In an alternative embodiment, the flat material can contain a mixture of, for the most part, uniformly mixed graphite expandate and plastic particles, the mixture being formed before the compaction. In a further alternative embodiment, the flat material can be impregnated superficially or down to the core region of the flat material with plastic applied after the compaction. Through these embodiments, dimensionally stable and easily manageable heat dissipaters can be formed in an advantageous manner. As plastics, use may advantageously be made of thermoplastics, thermosetting plastics or elastomers, in particular fluoropolymer, PE, PVC, PP, PVDF, PEEK, benzoaxines and/or epoxy resins.

If the flat material advantageously contains a metallic coating at least on a front side intended for the connection to a cooling module, the heat dissipater can be soldered on. Furthermore, at least a partial region of at least one main face of the flat material can be provided with a metallic coating. This is the case, for example, with flat material provided over the whole area with a metallic coating.

In a preferred embodiment, the flat material can be formed trough-shaped with open or closed short sides, so that on the one hand a good heat-conducting, large-area connection with a cooling module of an energy storage device and on the other hand easy manageability of the heat dissipater and insertability of the battery cells into the heat dissipater are enabled. In an alternative embodiment, the flat material can be formed undulating or meandering, honeycomb-like or in the shape of an 8, as a result of which a good, large-area contact with the battery cells is enabled, with at the same time rapid assembly of the heat dissipater in the energy storage device.

The heat dissipater or dissipaters of the energy storage device can preferably be constituted as described above and below. In order to enable a good heat transfer between a battery cell, the latter can advantageously be surrounded by a heat dissipater adapted to its external contour. For example, the heat dissipater or dissipaters can be trough-shaped in the case of rectangular battery cells, honeycomb-shaped in the case of battery cells hexagonal in cross-section, undulating in the case of round battery cells or in the shape of an 8, in order to enable a snug fit of the heat dissipater or dissipaters with the external faces of the battery cells over the largest possible area. In an embodiment of the invention, the energy storage device can contain a plurality of essentially rectangular battery cells, the flat material of the heat dissipater or dissipaters being disposed between adjacent external faces of at least some adjacent battery cells.

In a further embodiment, front sides and/or partial faces of the flat material of the heat dissipater or dissipaters can be connected in a heat-conducting manner to a cooling module of the energy storage device, as a result of which heat introduced into the heat dissipaters from the battery cells can advantageously be removed from the energy storage device. To advantage, the base or a part of the base of the energy storage device can be formed by the cooling module, as a result of which the linkage of the heat dissipaters to the cooling module is easily enabled. In an embodiment that is advantageous for the greatest possible heat transfer, the trough-shaped heat dissipater or dissipaters with their trough bottoms are connected in a heat-conducting manner to the base part or cooling module. Internal walls of a housing of the energy storage device can also advantageously be lined with the flat material according to the invention, which makes flush contact with corresponding lateral faces of the battery cells in order to provide for additional heat removal.

The bottom of a central pocket formed by the facing lateral faces of the heat dissipaters can advantageously also be provided with a heat dissipater, in order to provide for a rapid heat distribution and removal of thermal energy also on the lower front side of the central battery cell. In an embodiment, it is also possible advantageously to provide a base between heat dissipaters with matching strips of heat dissipater or continuously with one heat dissipater for better adaptation of the battery cell to the cooling module and for better heat removal.

For a more reliable heat-conducting connection of the flat material to the battery cells, the flat material of the heat dissipater or dissipaters can advantageously be constituted such that it expands in the presence of a volume reduction of the battery cells and yields in the presence of a volume expansion of the battery cells. In order to enable the volume expansion, which does not occur until the battery cells are in operation, the heat dissipaters and the battery cells can be advantageously clamped together in the non-operational state of the energy storage device in such a way that the flat material of the heat dissipater or dissipaters is compressed only slightly in the thickness direction, preferably by at most 1% related to its initial thickness.

The heat dissipaters according to the invention described above and below can be used advantageously in electrical energy storage devices with lithium ion battery cells, wherein a spring-loaded, mechanical pretensioning device for clamping the battery cells in the energy storage device is no longer necessary due to the use of the compressible and elastically recovering heat dissipaters.

Other features which are considered as characteristic for the invention are set forth in the appended claims.

Although the invention is illustrated and described herein as embodied in an heat dissipater and an electrical energy storage device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic perspective view of an electrical energy storage device according to the invention;

FIG. 2 is a longitudinal sectional view through a second embodiment of the energy storage device according to the invention;

FIG. 3 is a longitudinal sectional view through a third embodiment of the energy storage device according to the invention;

FIG. 4 is a plan view of a fourth embodiment of the energy storage device according to the invention;

FIG. 5 is a plan view of a fifth embodiment of the energy storage device according to the invention;

FIG. 6 is a plan view of a sixth embodiment of the energy storage device according to the invention; and

FIGS. 7A-7C are cross-sectional views through various embodiments of heat dissipaters according to the invention.

### DETAILED DESCRIPTION OF THE INVENTION

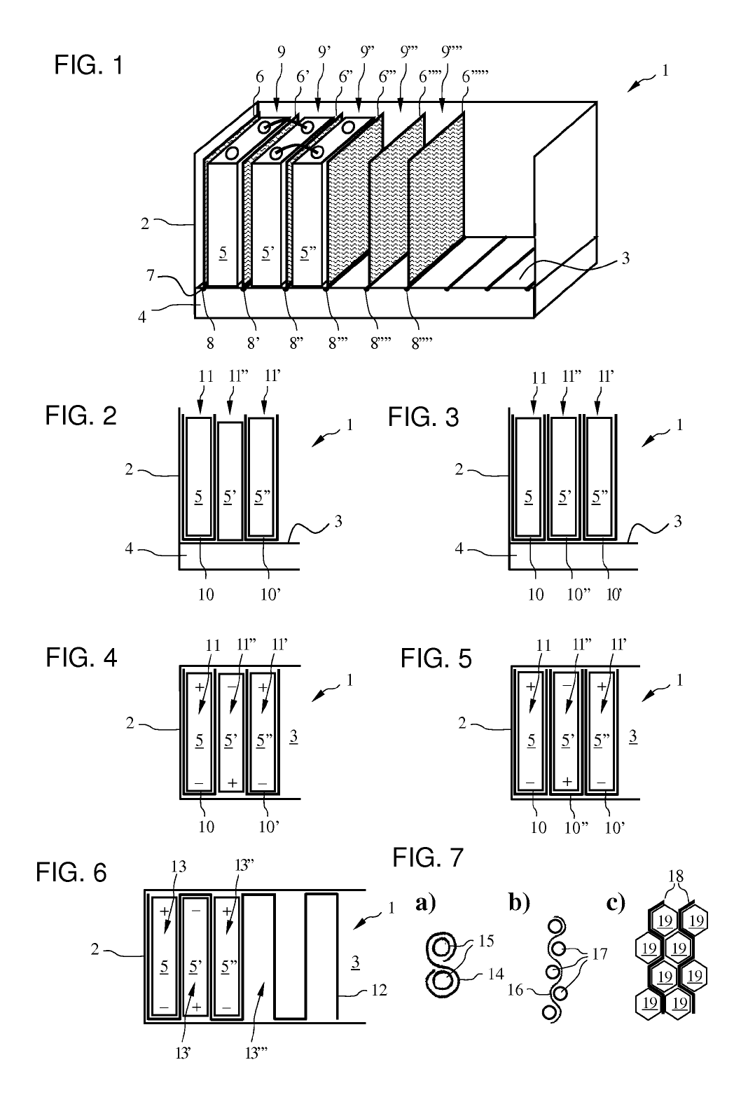

Referring now to the figures of the drawing in detail and first, particularly, to FIG. 1 thereof, there is shown an electrical energy storage device 1, in a partially broken-away, diagrammatic three-dimensional representation, and contains an essentially box-shaped housing 2 with a housing base 3. The housing base 3 is formed by a cooling module 4 represented diagrammatically in FIG. 1, which can be an active or passive cooling module and is made of a material with good thermal conductivity and with a heat storage capacity as good as possible, e.g. aluminum. The cooling module 4 can preferably contain cooling fins not represented in FIG. 1 and/or channels for the passage of a cooling medium, for example water. The housing 2 is completely equipped with lithium ion battery cells, only three battery cells 5, 5′, 5″ being shown in FIG. 1 for reasons of better representation.

Heat dissipaters 6 and respectively 6′ and 6″ are inserted according to the invention between the, in FIG. 1, left-hand side wall of housing 2 and adjacent battery cell 5 and also between adjacent battery cells 5 and 5′ and respectively 5′ and 5″. The heat dissipaters 6″, 6′″ and 6′″″ are also shown in FIG. 1; further heat dissipaters are not shown for reasons of better representation.

The heat dissipaters 6 to 6′″″ contain a flat material of rigidified, expanded graphite, so-called graphite expandate. The production of graphite expandate is sufficiently well known, for example from U.S. Pat. No. 3,404,061 A or German patent DE 103 41 255 B4, corresponding to U.S. Pat. No. 7,132,629. For the production of expanded graphite, graphite intercalation compounds or graphite salts, such as for example graphite hydrogen sulfate, are heated abruptly. The volume of the graphite particles thus increases by a factor of approximately 200-400 and at the same time the bulk density falls to values of 2-20 g/l. The graphite expandate thus obtained contains worm-shaped or accordion-shaped aggregates. The graphite expandate is then compacted by the directed action of a pressure, so that the layer planes of the graphite are preferably disposed normal to the direction of action of the pressure and the individual aggregates interlock with one another. A flat material according to the invention is thus obtained, which amongst other things can be pressed in a mould and is sufficiently stable and capable of keeping its shape for handling purposes. A flat material suitable for the present use is produced and marketed by the applicant or its associated companies under the brand name SIGRAFLEX.

The heat dissipaters 6 to 6′″″, or more precisely the flat material, have in the present case a density of 1.0 g/cm³, which corresponds to a thermal conductivity in the planar direction of 180 to 190 W/(mK). The heat dissipaters 6 to 6′″″ can also be compressed by at least 10% in the thickness direction. Furthermore, the heat dissipaters 6 have an elastic recovery of 10% related to their initial thickness in the thickness direction. In the example of heat dissipater 6′, this means that the latter is compressed in the presence of a volume expansion of, for example, 4% of battery cells 5 and 5′. With normal clamping of lithium ion battery cells 5, 5′, 5″, heat dissipater 6′, in the presence of the volume reduction following the 4-percent volume expansion, expands again by 8% in the thickness direction (elastic recovery), as a result of which the volume changes of battery cells 5 and 5′ in the two directions—volume expansion and volume reduction—are fully compensated. The heat dissipater 6 therefore lies between the battery cells 5, 5′ always over the whole area at the lateral faces of battery cells 5, 5′, so that a good heat transfer is always ensured. Other heat dissipaters 6 to 6′″″ have corresponding properties and behave accordingly.

In order to be able to carry away rapidly the thermal energy introduced into heat dissipaters 6 from battery cells 5, 5′, 5″, heat dissipater 6 is inserted with a lower front side 7 into a groove 8 in cooling module 4 and is connected to the latter in a good heat-conducting manner. The other heat dissipaters 6′ to 6′″″ are also connected in a good heat-conducting manner to cooling module 4 in the same way in grooves 8′ to 8′″″. The heat dissipater 6 can preferably be glued there with a heat-conducting glue.

If, in an advantageous embodiment not shown, the heat dissipater contains a metallic coating at least in the region of its lower front side or also over the whole area, it can also be soldered to cooling module 4. Alternatively, the heat dissipater 6 can also be attached by gluing or welding.

In an embodiment that is advantageous from the production standpoint, the heat dissipaters 6′ to 6′″″ are constituted as dimensionally stable and rigid foils or plates, which can be achieved, amongst other things, by compaction of the flat material of heat dissipaters 6′ to 6′″″ by pressure or also by subsequent impregnation with a plastic. Alternatively, the flat material can also contain a mixture of, for the most part, uniformly mixed particles of graphite expandate and plastic formed before the compaction, the particles then being pressed together and if need be heated and thus being able to be formed into a rigid, dimensionally stable foil or plate. In the production of the energy storage device, base 3 can therefore first be fitted with the heat dissipaters 6′ to 6′″″, and the battery cells 5, 5′, 5″ as well as the further battery cells not shown in FIG. 1 are then merely inserted into pockets 9′ to 9″″ formed by heat dissipaters 6′ to 6′″″. Since the battery cells of energy storage device 1 are clamped together, gluing of the heat dissipaters to the battery cells is in principle not necessary, so that easy replacement of individual or all battery cells and if need be heat dissipaters is possible.

The heat dissipaters 6′ to 6′″″ and battery cells 5′ to 5″ are advantageously inserted into housing 2 only with slight pretensioning or surface pressure, in order not to produce excessively high mechanical stresses in the presence of a volume expansion of battery cells 5′ to 5″ during operation despite compressible heat dissipaters 6′ to 6′″″. Particularly in the case of lithium ion battery cells, additional elements, which enable clamping of the battery cells with simultaneous expandability, e.g. clamping means provided with springs, can be avoided by means of the heat dissipaters according to the invention.

FIG. 2 shows an alternative embodiment of the invention, which differs from the embodiment according to FIG. 1 essentially by the formation and fitting of the heat dissipaters at the base 3 of energy storage device 1. Identical parts are therefore denoted by the same reference numbers and the differences will essentially be dealt with.

In contrast with the embodiment shown in FIG. 1, heat dissipaters 10, 10′ are constituted as U-shaped or trough-shaped flat material made of compressed graphite expandate in the embodiment shown in FIG. 2. Trough-shaped heat dissipaters 10, 10′ are fixed here with their trough bottoms to base 3, preferably by gluing. If the flat material advantageously contains a plastic fraction, at least in the region of the trough bottom of heat dissipaters 10, 10′, the latter can be welded to base 3, if appropriate also advantageously only spot-wise. There are formed by the lateral faces of heat dissipaters 10 and 10′ pockets 11, 11′ and 11″, into which battery cells 5, 5′, 5″ can be inserted. The spacing of the lateral faces of heat dissipaters 10 and 10′ from one another as well as the spacing of facing lateral faces of adjacent heat dissipaters 10, 10′ is selected here with a dimension such that on the one hand battery cells 5, 5′ and 5″ can be inserted from above and on the other hand the lateral faces of heat dissipaters 10, 10′ lie snugly adjacent to the corresponding lateral faces of battery cells 5, 5′ and 5″.

In an embodiment not shown in FIG. 2, the base 3 of the middle pocket 11″ formed by the facing lateral faces of heat dissipaters 10, 10′ can also be provided with a graphite expandate foil, in order to provide a rapid heat distribution and removal of thermal energy also on the lower front side of middle battery cell 5′. In an embodiment not shown in FIG. 1, the base 3 can also be provided between the heat dissipaters 6′, 6″, 6′″ etc. with matching strips of graphite expandate foil or a continuous base coating for better adaptation of the battery cell to the cooling module and for better heat removal.

If, in contrast with the example of embodiment shown in FIG. 2, a more rapid and better heat distribution and heat removal is to be made possible, a further heat dissipater 10″ correspondingly constituted as a trough-shaped flat element is inserted between heat dissipaters 10 and 10′, as shown in FIG. 3, the spacing of heat dissipaters 10 and 10′ from one another correspondingly being enlarged. The fixing of heat dissipater 10″ and the further constitution of energy storage device 1 correspond to that described above in respect of FIG. 2.

The embodiments of energy storage device 1 according to the invention shown in FIG. 4 and FIG. 5 essentially correspond respectively to the embodiments shown in FIG. 2 and FIG. 3, but differ in the nature of the arrangement and fixing of the heat dissipaters in the housing 2. The same reference numbers are therefore used for the same parts as those in preceding FIGS. 1 to 3.

In the plan view of an electrical energy storage device 1 shown in FIG. 4, the heat dissipaters 10, 10′ containing trough-shaped flat material made of compacted graphite expandate are again used. The latter are not however placed with their trough bottoms on the base 3, but with lateral front sides of a side of the trough profile. The front sides are then fixed to the base as described above, as a result of which good thermal conductivity is ensured. In an alternative embodiment not shown in FIG. 4, grooves 7 can be provided at the base in order to guarantee a secure support of the front sides of the heat dissipaters 10, 10′ and to improve the heat-conducting connection.

In order to enable a more rapid and better heat distribution and heat removal as in the case of the example of embodiment shown in FIG. 3, a further heat dissipater 10″ is again inserted directly between the heat dissipaters 10 and 10′ in the example of embodiment shown in FIG. 5. The orientation, arrangement and fixing of the heat dissipaters 10, 10′, 10″ otherwise corresponds to the embodiment shown in FIG. 4.

In the further example of embodiment of the invention represented in plan view in FIG. 6, a single heat dissipater 12 containing a meandering flat material is used instead of individual plate-shaped heat dissipaters 6′ to 6′″″ shown in FIG. 1 or trough-shaped heat dissipaters 10, 10′, 10″ shown in FIGS. 2 to 5. The heat dissipater 12 is inserted from above with one of its lateral front sides into housing 2 of energy storage device 1, so that pockets 13, 13′, 13″, 13′″ etc. are again formed for battery cells 5, 5′, 5″ as well as further battery cells not shown. The linkage of the heat dissipater 12 to the base 3 and therefore to the cooling module 4 takes place as in the case of the embodiments described in FIG. 1 and respectively 4 and 5. The embodiment shown in FIG. 6 also has the advantage of a very rapid assembly, since the individual windings of meandering heat dissipater 12 can already be preformed at the desired distance from one another adapted to the width of battery cells 5, 5′, 5″.

FIGS. 7A-7C show further embodiments of a heat dissipater according to the invention. Thus, FIG. 7A shows a heat dissipater 14 with a cross-section in the shape of an 8. Two pockets are thus formed for two battery cells 15 constituted cylindrical or round, the latter fitting flush with heat dissipater 14.

FIG. 7B represents a heat dissipater 16 with an undulating cross-section, wherein cylindrical battery cells 17 are disposed on both sides in its wave troughs, the battery cells fitting snugly with the flat material of heat dissipater 16.

In FIG. 7C, a plurality of hexagonal battery cells 19 are disposed on heat dissipaters 18 formed honeycomb-like in cross-section, in such a way that a plurality of their lateral faces fit snugly with the flat material of heat dissipater 18. Pockets for the insertion of battery cells 19 are also formed here by the shape of heat dissipaters 18.

1. A heat dissipater, comprising:
a body formed of a graphite-containing flat material provided for adjacent positioning against at least one battery cell, said graphite-containing flat material having a graphite expandate.

2. The heat dissipater according to claim 1, wherein said graphite-containing flat material has a density of 0.6-1.4 g/cm³.

3. The heat dissipater according to claim 1, wherein said graphite-containing flat material has a thermal conductivity in a planar direction of 120-240 W/(mK).

4. The heat dissipater according to claim 1, wherein said graphite-containing flat material in a thickness direction has an elastic recovery of 0.5-15% related to an initial thickness.

5. The heat dissipater according to claim 1, wherein said graphite-containing flat material in a thickness direction has a compressibility of 1-50% related to an initial thickness.

6. The heat dissipater according to claim 1, wherein said graphite-containing flat material is made from compacted graphite expandate.

7. The heat dissipater according to claim 6, wherein said graphite-containing flat material includes a mixture of uniformly mixed graphite expandate and plastic particles, said mixture being formed before compaction.

8. The heat dissipater according to claim 1, wherein said graphite-containing flat material is impregnated superficially or down to a core region of said graphite-containing flat material with plastic applied after compaction.

9. An electrical energy storage device, comprising:
at least one battery cell having external faces; and
a heat dissipater for removing heat from said battery cell, said heat dissipater having a graphite-containing flat material and disposed on at least one of said external faces of said battery cell, said graphite-containing flat material containing a graphite expandate.

10. The energy storage device according to claim 9, wherein said graphite-containing flat material has a density of 0.6-1.4 g/cm³.

11. The energy storage device according to claim 9, wherein said at least one battery cell is surrounded by said heat dissipater being adapted to an external contour of said battery cell.

12. The energy storage device according to claim 9, further comprising a cooling module, said graphite-containing flat material having front sides and partial faces being connected in a heat-conducting manner to said cooling module.

13. The energy storage device according to claim 12, further comprising a housing having a base part functioning as and being said cooling element.

14. The energy storage device according to claim 13, wherein said housing has at least one internal wall lined with said graphite-containing flat material for contacting of said external faces of said at least one battery cell for removing the heat from said battery cell.

15. The energy storage device according to claim 13, wherein said heat dissipater is one of a plurality of heat dissipaters having shapes selected from the group consisting of trough-shapes, undulating shapes, meandering shapes and honeycomb-like shapes, said heat dissipaters connected with one of their front sides to said base part in a heat-conducting manner.

16. The energy storage device according to claim 9, wherein said at least one battery cell is one of a plurality of battery cells being lithium ion battery cells.

17. The energy storage device according to claim 9, wherein:
said heat dissipater is one of a plurality of heat dissipaters; and
said at least one battery cell is one of a plurality of battery cells which reduce their volume during operation and, in order to secure a heat-conducting connection between said battery cells and said heat dissipaters, said graphite-containing flat material of said heat dissipaters recovering elastically in a thickness direction by 0.5-15% related to an initial thickness.

18. The energy storage device according to claim 9, wherein:
said heat dissipater is one of a plurality of heat dissipaters; and
said at least one battery cell is one of a plurality of battery cells, said battery cells expand during operation and, in order to secure a heat-conducting connection between said battery cells and said heat dissipaters, said graphite-containing flat material of said dissipaters can be compressed in a thickness direction by 1-50% related to an initial thickness.

19. The energy storage device according to claim 9, wherein:
said heat dissipater is one of a plurality of heat dissipaters; and
said at least one battery cell is one of a plurality of battery cells, said heat dissipaters and said battery cells are clamped together in a non-operational state of the energy storage device such that said graphite-containing flat material of said heat dissipaters is compressed only at most 1% in a thickness direction, related to an initial thickness.
